(19) United States
(12) Patent Application Publication
(10) Pub. No.: US 2007/0247086 A1
(43) Pub. Date: Oct. 25, 2007

(54) Portable wireless remote-controlled dimmer socket

(76) Inventor: Shih-Yung Chiu, Sindian City (TW)

Correspondence Address: BACON & THOMAS, PLLC, 625 SLATERS LANE, FOURTH FLOOR, ALEXANDRIA, VA, 22314, US

(21) Appl. No.: 11/407,943

(22) Filed: Apr. 21, 2006

(51) Int. Cl. H05B 37/02

(52) U.S. Cl. 315/291

(57) ABSTRACT

A portable wireless remote-controlled dimmer socket comprises a housing having a power supply outlet and a power source inlet port formed on the housing and having a remote dimmer control circuit installed inside, and the portable wireless remote-controlled dimmer socket provides both power supply function and dimmer adjustment control function convenient for a general lighting-equipment by means of plug-and-play to become having function of dimmer adjustment.

### BACKGROUND OF THE PRESENT INVENTION

1. Field of the Present Invention

The present invention relates to a portable wireless remote-controlled dimmer socket, more particularly to a portable electrical socket having RF remote-controlled dimmer function applicable by means of plug-and-play to control the brightness of a lighting-equipment.

2. Description of Prior Act

As illustrated in FIG. 1, a conventional lighting-equipment 90 with wireless remote-controlled dimmer function is generally adapted to a remotely control dimmer controller 70 installed inside the lighting-equipment 90 and electrically connected between a lamp 91 and an outlet 80 to switch the brightness of the lamp 91 due to the remotely control dimmer controller 70 capable of adjusting and changing conduction angle of the lamp 91 of the lighting-equipment 90 by RF signal transmitted from a wireless transmitter.

However, a general lighting-equipment has no function of dimmer adjustment when it is in use, and it is hard to refit the general lighting-equipment provided with dimmer function by way of further re-installing a remotely control dimmer controller inside.

Therefore, it will be very useful to users if there is a portable wireless remote-controlled dimmer socket easily applicable for any general lighting-equipment by means of plug-and-play to become having function of wireless remote-controlled dimmer adjustment.

### SUMMARY OF THE PRESENT INVENTION

It is therefore a primary objective of the present invention to provide a portable wireless remote-controlled dimmer socket having power supply function and dimmer adjustment control function convenient for a general lighting-equipment by means of plug-and-play to have function of dimmer adjustment.

The second objective of the present invention is to provide a portable wireless remote-controlled dimmer socket which comprises a housing having a power supply outlet and a power source inlet port formed on the housing respectively and having a remote dimmer control circuit installed inside, wherein the remote dimmer control circuit comprises a receiver for receiving RF signal transmitted from a wireless transmitter; a microcontroller (MCU) for identifying and decoding the RF signal received by the receiver and then output control signal accordingly; a power output with phase control circuit controlled by the output control signal of the microcontroller (MCU) to adjust and change conduction angle of power supply output from the power supply outlet; and a DC power circuit, for supplying 5V direct current to the receiver and the microcontroller (MCU).

### BRIEF DESCRIPTION OF THE DRAWING FIGURES

FIG. 1 is an illustrative view of a conventional lighting-equipment with wireless remote-controlled dimmer function by use of a remotely control dimmer controller installed inside.

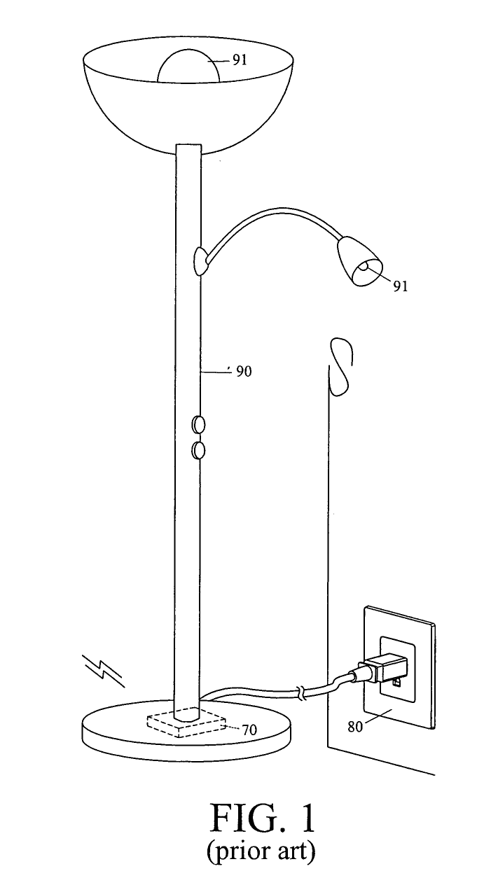

FIG. 2 is a schematic drawing of the portable wireless remote-controlled dimmer socket of the present invention.

FIG. 3 is a schematic circuit diagram of the portable wireless remote-controlled dimmer socket of the present invention for depicting the relation between components and the position of each component.

FIG. 4 is an illustrative view of the portable wireless remote-controlled dimmer socket of the present invention applicable for a general lighting-equipment by means of plug-and-play to become having function of wireless remote-controlled dimmer adjustment.

### DETAILED DESCRIPTION OF THE PREFERRED EMBODIMENTS

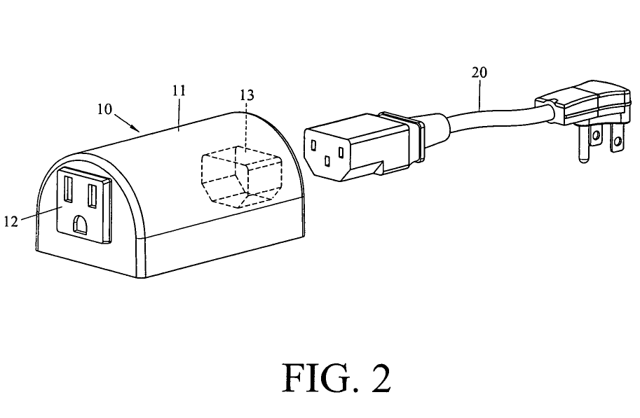

Referring to FIGS. 2 to 4, a portable wireless remote-controlled dimmer socket 10 of the invention, hereinafter abbreviated as portable dimmer socket 10, comprises a housing 11 having a power supply outlet 12 and a power source inlet port 13 formed on the housing 11 respectively and having a remote dimmer control circuit 30 installed inside.

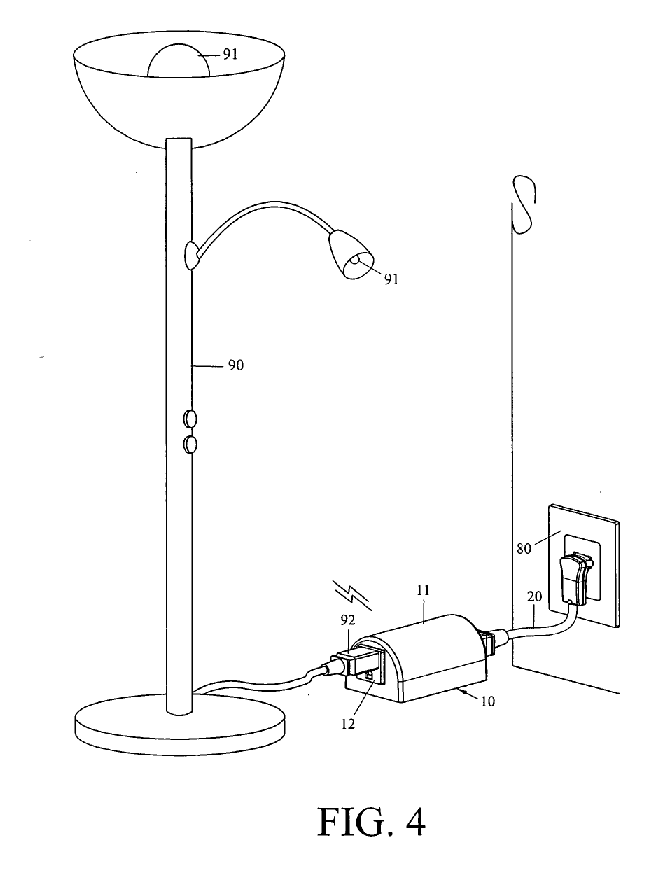

As shown in FIG. 4, the power source inlet port 13 of the portable dimmer socket 10 is used to electrically connect to a power source, so that a power source suitably provided for the portable dimmer socket 10 shall be easily supplied from an outlet 80 through a detachable power supply cord 20 by means of plug-and-play to connect its one end into the power source inlet port 13 of the portable dimmer socket 10 and to form an electrical connection between the portable dimmer socket 10 and the outlet 80.

And, the power supply outlet 12 formed on the portable dimmer socket 10 is functioned as a power supply source for any lighting-equipment 90 having a plug 92 used to be plugged into the power supply outlet 12.

The remote dimmer control circuit 30 installed inside the portable dimmer socket 10 comprises a receiver 31, a microcontroller (MCU) 32, a power output with phase control circuit 33, and a DC power circuit 34. Wherein the DC power circuit 34 supplies the power required by the receiver 31 and the microcontroller (MCU) 32 after a transformer converts from 110 V˜230V alternate current into a 5V direct current.

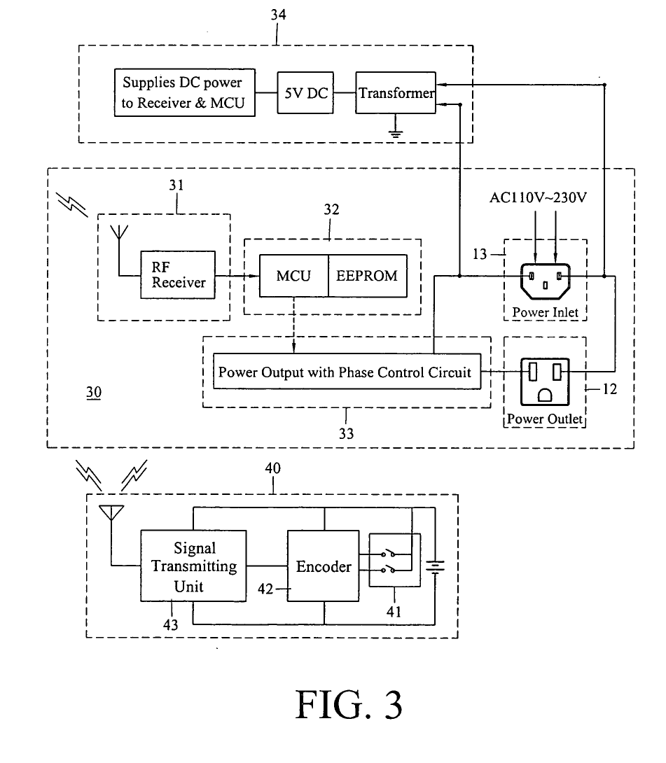

As shown in FIG. 3, the function of receiver 31 is to receive the identification code and the RF signal transmitted from a wireless transmitter 40 and send the received identification code and RF signal to the input port of the microcontroller (MCU) 32.

The microcontroller (MCU) 32 is an IC component that independently carries out specific control functions and integrates the related circuits for the central processing unit (CPU), read-on memory (ROM), electrically erasable programmable read-on memory (EEPROM), random access memory, I/O control circuit and CTC timer on a single chip.

Since the ROM or EEPROM of the microcontroller (MCU) 32 contains the information of the identification code and the RF signal of the corresponding decoding, therefore, after the identification code received by the receiver 31 is confirmed, the microcontroller (MCU) 32 will accord the input corresponding RF signal and corresponding decoded control signal to control the power output with phase control circuit 33 in such a way of adjusting and changing conduction angle of power supply output from the power supply outlet 12 of the portable dimmer socket 10.

As shown in FIG. 3, a wireless transmitter 40 suitably applicable for the portable dimmer socket 10 of the invention comprises a plurality of press buttons 41, an encoder 42 and a signal transmitting unit 43. When a user presses the press button 41 of the transmitter 40, the press button 41 is to control the encoder 42 of the wireless transmitter 40 to generate an identification code with corresponding radio frequency RF signal information, and transmits the identification code and the RF signal from the signal transmitting unit 43 by surface acoustic waves SAW.

Therefore, the wireless transmitter 40 is capable of sending out the RF control signal to the portable dimmer socket 10 of the invention, and the RF control signal transmitted from the wireless transmitter 40 shall comprise a Power On/Off signal and a phase control signal to adjust and change conduction angle of power supply output from the power supply outlet 12 of the invention.

Accordingly mentioned above, the portable dimmer socket 10 of the invention is then functioned as a portable electrical socket particularly with both power supply function and dimmer adjustment control function, and capably applied for any general lighting-equipment 90 having function of dimmer adjustment by wireless remotely control.

As shown in FIG. 4, if a general lighting-equipment 90 makes use of the portable dimmer socket 10 of the invention as power supply source, the general lighting-equipment 90 is then provided with an advantageous function of dimmer adjustment after the general lighting-equipment 90 by means of plug-and-play have had its plug 92 plugged into the power supply outlet 12 of the portable dimmer socket 10. Resulted in that the brightness of a lamp 91 installed on the general lighting-equipment 90 is become adjustable by wireless remotely control from a wireless transmitter 40.

While a preferred embodiment of the invention has been described above, it is to be understood that the invention is still not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A portable wireless remote-controlled dimmer socket having power supply function and dimmer adjustment control function for a general lighting-equipment, comprising a housing having a power supply outlet and a power source inlet port formed on the housing respectively and having a remote dimmer control circuit installed inside, wherein the remote dimmer control circuit comprising:
a receiver, for receiving RF signal transmitted from a wireless transmitter;
a microcontroller (MCU), for identifying and decoding the RF signal received by the receiver and then output control signal accordingly;
a power output with phase control circuit, controlled by the output control signal of the microcontroller (MCU) to adjust and change conduction angle of power supply output from the power supply outlet; and
a DC power circuit, for supplying 5V direct current to the receiver and the microcontroller (MCU).
